(19) United States
(12) Patent Application Publication
(10) Pub. No.: US 2017/0117507 A1
(43) Pub. Date: Apr. 27, 2017

(54) SECONDARY BATTERY CASE MANUFACTURING METHOD

(71) Applicant: Byung In Kong, Goyang-si (KR)

(72) Inventor: Byung In Kong, Goyang-si (KR)

(21) Appl. No.: 14/990,025

(22) Filed: Jan. 7, 2016

(30) Foreign Application Priority Data
Oct. 21, 2015 (KR) 10-2015-0146467

(51) Int. Cl. H01M 2/02; B21J 5/00; B21J 5/06

(52) U.S. Cl. CPC H01M 2/02; B21J 5/06; B21J 5/002

(57) ABSTRACT

A secondary battery case manufacturing method of the present disclosure includes preparing a material, forming an impact formed product by performing impact forging on the material with a die and a punch, and obtaining a complete product by applying ironing on the impact formed product.

### RELATED APPLICATIONS

This application claims priority to Korean Patent Application No. 10-2015-0146467, filed Oct. 21, 2015, and which is hereby incorporated by reference in its entirety.

### FIELD OF THE DISCLOSURE

The present disclosure relates to a secondary battery case manufacturing method, and more particularly, to a secondary battery case manufacturing method that can greatly reduce work processes and the cost of a raw material.

### BACKGROUND

In general, a secondary battery, a battery that can be charged and discharged unlike primary battery that cannot be charged, is widely used as a power source for activating various portable electronic devices such as a mobile telephone, a notebook, a digital camera, and an MP3 player.

Further, a secondary battery attracts attention as a power source for an electric vehicle (EV), a hybrid electric vehicle (HEV), and the like, that are proposed as measures for solving the air pollution problem with gasoline vehicles, diesel vehicles, and the like using fossil fuel.

Battery modules including such a secondary battery are use one or two to four battery cells per device such as small mobile devices, while middle or large battery modules manufactured by electrically connecting a plurality of battery cells are used for middle and large device such as a vehicle due to the necessity of high power and large capacity.

Those battery modules are manufactured in various shapes and middle and large battery modules are manufactured by connecting a plurality of high-power battery cells in series and putting them in a secondary battery case to be used for activating a device requiring a large amount of power such as motors in electric vehicles.

Such a case is manufactured in an aluminum case (can) to effectively remove heat of a battery cell or reduce the weight.

In particular, such an aluminum can can be made thin, so it is possible to volume energy density of the entire battery by removing more battery active substances in comparison to cases made of different materials in the same shape. That is, weight of the entire battery decreases, and weigh energy density is improved.

Such a secondary battery aluminum case is manufactured generally by deep drawing that is an existing engineering process for aluminum cases (cans).

Wet lubricant is continuously applied to a cold-rolling material in the cases manufactured by deep drawing, so the surface luster is excellent.

However, in the deep drawing, a raw material is punched in an elliptical shape by a cold-rolling material, in which the yield ratio is very low at 60 to 70%, so the raw material cost is high.

Further, as ten to fifth processes are repeated in wet lubricating, the facility is increased in size by the complicated processes, the cost is increased by necessary molds as much as the processes, the molds are complicated, and technical skills are required to satisfy continuous conditions, so it can be considered as an expensive engineering process.

Further, since wet lubricating is used, there is a limit in overcoming friction between metal, a large facility is required because the stroke of the facility is long, and the production speed per minute that determines productivity is low, at maximum 20 times.

In order to solve these problems, a method of manufacturing a secondary battery case through impact forging has been proposed.

Accordingly, it is required to develop a method of manufacturing a secondary battery case using impact forging to solve the problem with productivity.

### SUMMARY

The present disclosure describes a secondary battery case manufacturing method that can greatly reduce work processes and a raw material cost.

In one embodiment of the present disclosure, a secondary battery case manufacturing method includes: I) preparing a material; II) forming an impact formed product by performing impact forging on the material with a die and a punch; and III) obtaining a complete product by applying ironing on the impact formed product.

Further, the material is obtained by cutting an extruding material with both ends of a cross-section formed in a semicircular shape or the corner rounded, and both ends of the cut side is formed in a semicircular shape or the corners of the cut side are rounded through pre-forging.

Further, rounded portions are formed at short sides and long sides at an inlet of the die and the rounded portion of the short side is larger than the rounded portion of the long side.

Further, the rounded portion of the short side at the inlet of the die is two to five-time larger than the rounded portion of the long side.

Further, a land is attached to the punch at the portion facing the die and has long sides higher than short sides.

Further, the long sides of the land are higher than the short sides only in the range of 50 to 80% of the center.

Further, the height of the long sides of the land is two to five-time larger than the short sides.

Further, an assembly ring is wound around the outer side of the die and the inner diameter of the assembly ring is smaller than the outer diameter of the die.

Further, a larger tolerance is given to the long sides than the short sides of the material and the die.

Further, a tapered portion is formed from a long side to a short side of the bottom of the die.

Further, the long side of the die except for the tapered portion has a size for completing the bottom of the complete product, the end is rounded, and the tapered portion is formed at 45% in the range of 1 to 3% of the length of the long side.

According to the secondary battery case manufacturing method of the present disclosure, the shape of a case is achieved by 90% through impact forging, dimensional precision and surface luster are achieved by ironing, and worm processes and a raw material cost can be largely reduced in comparison to deep drawing.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a diagram illustrating a process of a secondary battery case manufacturing method according to the present disclosure;

FIG. 2 is a diagram illustrating a formed product according to the processes illustrated in FIG. 1;

FIG. 3 is a diagram illustrating a die according to the present disclosure;

FIG. 4 is a diagram illustrating a die and a punch according to the present disclosure;

FIG. 5 is a diagram illustrating materials for deep drawing and impact forging;

FIG. 6 is a diagram illustrating an extruding body used for pre-forging;

FIG. 7 is a diagram illustrating a shape relationship between a die and a material according to the present disclosure; and

FIG. 8 is a diagram for partially enlarging a die.

### DETAILED DESCRIPTION

Hereinafter, various embodiments of the present disclosure will be described with reference to the accompanying drawings. The embodiments are provided so that those skilled in the art can sufficiently understand the present disclosure, but can be modified in various forms and the scope of the present disclosure is not limited to the disclosed embodiments.

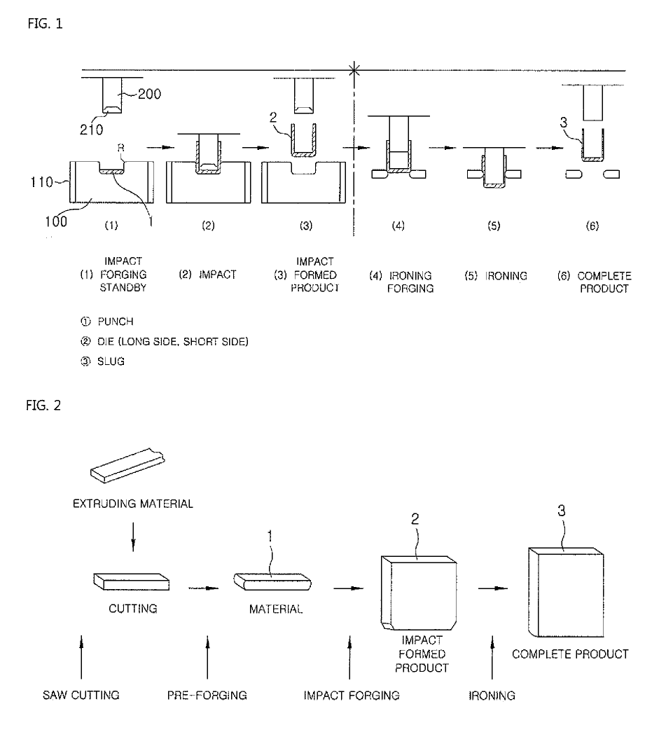

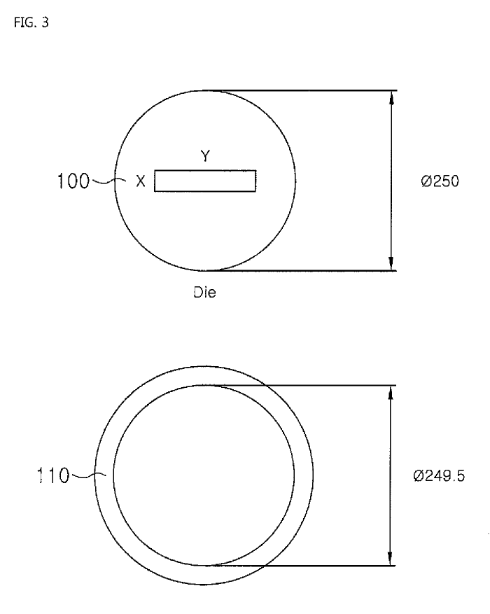

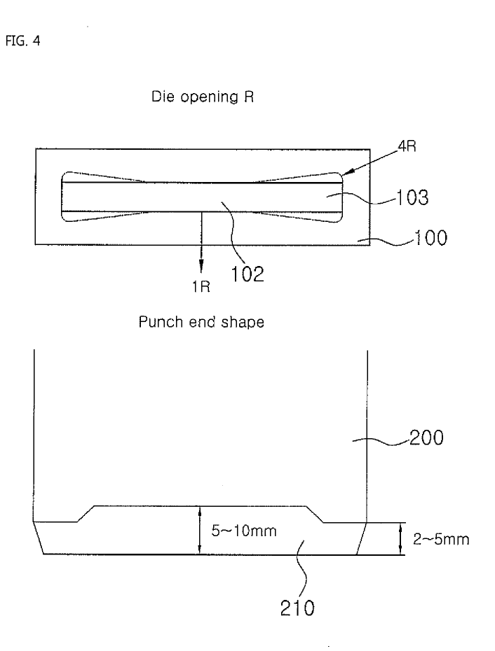

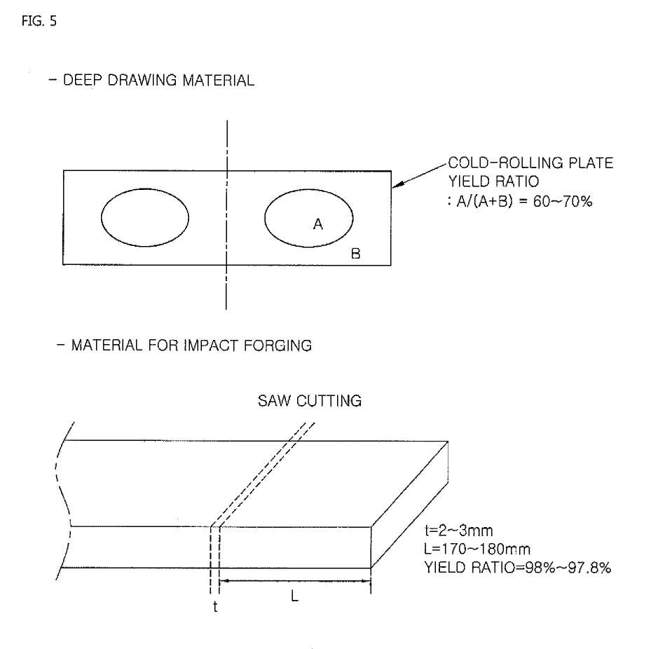

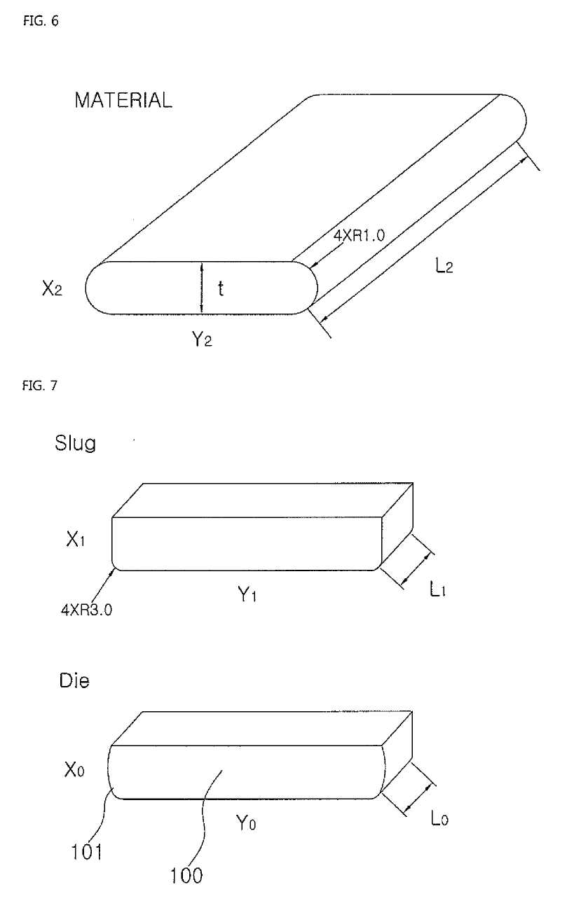

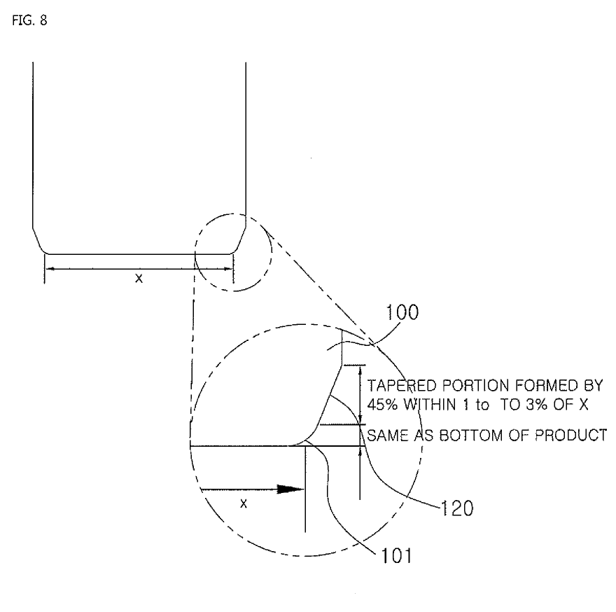

FIG. 1 is a diagram illustrating process of a secondary battery case manufacturing method according to the present disclosure, FIG. 2 is a diagram illustrating a formed product according to the processes illustrated in FIG. 1, FIG. 3 is a diagram illustrating a die according to the present disclosure, FIG. 4 is a diagram illustrating a die and a punch according to the present disclosure, FIG. 5 is a diagram illustrating materials for deep drawing and impact forging, FIG. 6 is a diagram illustrating an extruding body used for pre-process forging, FIG. 7 is a diagram illustrating a shape relationship between a die and a material according to the present disclosure, FIG. 8 is a diagram partially enlarging a die.

As illustrated in FIGS. 1 to 8, according to a secondary battery case manufacturing method of the present disclosure, a material 1 is prepared first, an impact formed product 2 is formed by applying impact forging on the first material 1 using a die 100 and a punch 200, and then the impact formed product is manufactured into a complete product 3 through ironing, thereby manufacturing a secondary battery case.

Accordingly, in this embodiment, the shape of an aluminum case is achieved by 90% by impact forging in consideration of plastic properties of aluminum and a secondary battery case is manufactured by adding ironing one to two times to overcome the disadvantage in dimensional precision and luster that are vulnerable points of impact forging.

That is, the quality and thickness of the bottom of the complete product 3 (secondary battery case) are determined by the impact forging and the thickness of the walls is finally determined by ironing, so a precise dimensional tolerance can be achieved.

Success of the impact forging depends on the shape and size of the material 1 and the shapes of the punch 200 and the die 100.

First, in order to reduce the cost of the material 1, an extruding body that is cheaper than a cold-rolling material used in deep drawing is used, as illustrated in FIG. 5.

The cold-rolling material is punched into an ellipse for deep drawing, in which the yield ratio is very low at 60 to 70%. In contrast, the extruding material is cut by a saw, so the yield ratio is very high at 95 to 98%.

However, the surface of the material 1 cut by a saw interferes with flow of an end of aluminum in impact forging, so the material 1 is primarily forged to have a shape similar to the die 100 in the impact forging.

In detail, as illustrated in FIG. 2 or 5, the material 1 is obtained by cutting an extruding material with both ends of a cross-section formed in a semicircular shape or the corner rounded, and both ends of the cut side is formed in a semicircular shape or the corners of the cut side are rounded through pre-forging.

Accordingly, the problem with concentration on the long sides of the saw-cut side of the material 1 in impact forging.

Further, as in FIG. 7, in the dimensional relationship between the material 1 and the die 100, a large tolerance is applied to the long sides and a small tolerance is applied to the short sides. This is for matching the flow speeds of the short sides and the long sides of the complete product.

Further, rounded portions 101 are formed at the corners of the bottom of the die 100, similar to the bottom of the complete product.

On the other hand, impact forging can be applied to aluminum that is the material of the present disclosure for the properties of the material. When aluminum starts plastic deformation due to shock, the deformation speed is very high and mass also moves very fast in a predetermined direction.

That is, it is the most difficult to make the long and short sides uniform in impact forging of a rectangular aluminum material.

This is because mass necessarily concentrates on the long sides due to the properties of aluminum, so it is very difficult to control this phenomenon. Accordingly, this is one reason that deep drawing is necessary for manufacturing a rectangular aluminum case in the related art.

In order to control this concentration on long sides, the shape of the punch 200 and R at the inlet of the die 100 were adjusted in the present disclosure.

That is, the width of a land 210 at the lower portion of the punch 200 was adjusted and the R at the inlet of the die 100 was adjusted to control concentration on long sides by controlling friction resistance of aluminum.

In detail, rounded portions 102 and 103 are formed at the short side and the long side at the inlet of the die 100 and the rounded portion 103 of the short side is larger than the rounded portion of the long side.

This is for controlling the flow speeds of the short sides and the long sides of the material 1 by adjusting the friction area, because the flow speed of a material in impact forging is determined by the friction area between the wall of the die 100 and the punch 200.

This is because common dies without rounded portions has a fast flow speed at the long sides than the short sides.

That is, since the rounded portion 103 of the short side of the die 100 is larger than the rounded portion 102 of the long side of the die 100, the same flow speed is achieved at the short side and the long side of the material 1 in impact forging by making the length of the short side of the die smaller than the length of the long side of the die.

Accordingly, the walls of the impact formed product 2 are obtained at the same speed regardless of the short sides and the long sides.

In this case, the rounded portion 103 of the short side at the inlet of the die 100 is two to five-time larger than the rounded portion 102 of the long side.

Further, the rounded portion 103 of the long side is within the range of 50 to 80% of the center of the width of the die 100. That is, the long side out of the range of 50 to 80% of the center of the long side of the width of the die 100 is the same rounded size as the short side.

Further, the land 210 is attached to the punch 200 at the portion facing the die 100 and has long sides higher than short sides. This is also for adjusting the flow speeds of the short sides and the long sides of a material.

In this case, the long sides of the land 210 are higher than the short sides only in the range of 50 to 80% of the center and the height of the long sides of the land is two to five-time larger than the short sides.

Resultant values for controlling concentration on a long side are as in Table 1.

TABLE 1

| Item | Available range | Applied value |
|---|---|---|
| Land width | 50 to 80% of center of width | Long side 1.5 to 3 time |
| | of punch | larger |
| R value | 50 to 80% of center portion of | Short side 2 to 5 time larger |
| | upper width of die | |

Flow of a mold (die) or very small deformation due to impact in impact forging diffuses flow of aluminum that temporarily plastically deforms.

As a result, the hardness of the mold (die) may be desirable and deformation minimized.

Accordingly, in the present disclosure, the die 100 was not divided into several parts, but manufactured in a single unit, and an assembly way of applying reverse stress in advance to reduce shock pressure applied to the die 100 was employed.

In detail, as in FIG. 3, an assembly ring 110 is wound around the outer side of the die 100 and the inner diameter of the assembly ring 110 is smaller than the outer diameter of the die. The assembly ring 110 is shrink-fitted on the die 100.

Accordingly, impact forming pressure is offset by reverse stress by applying reverse stress to the die 100 when the die 100 and the assembly ring 110 are combined by shrink-fitting such that the die 100 receives stress under the range causing plastic deformation or elastic deformation, thereby preventing temporal deformation of the die 100.

In impact forging, the die 100 receives force for forming, and when the force exceeds the elastic limit of the material of the die 100, deformation is caused and shaking is generated accordingly in impact forming, so the impact formed product 2 explodes or shows flow of an incomplete formed product.

Accordingly, the assembly ring 110 is added when the die 100 is assembly to prevent the die 100 reaches the elastic limit, so contract stress is applied to the die 100.

Further, a tapered portion 120 is formed from a long side to a short side of the bottom of the die 100.

That is, if ironing that reduces the thickness from the bottom to the walls of the impact formed product 2 is applied without the tapered portion 120, the center of the long side of the bottom of the impact formed product 2 expands, and in order to prevent this expansion, the tapered portion 120 is formed on the die 100 and a tapered portion is formed on the impact formed product 2 too.

Finally, the long side of the die 100 except for the tapered portion 120 has a size for completing the bottom of the complete product, the end is rounded, and the tapered portion 120 is formed at 45% in the range of 1 to 3% of the length of the long side.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A secondary battery case manufacturing method, comprising:
preparing a material;
forming an impact formed product by performing impact forging on the material with a die and a punch; and
obtaining a complete product by applying ironing on the impact formed product.

2. The method of claim 1, wherein the material is obtained by cutting an extruding material with both ends of a cross-section formed in a semicircular shape or the corner rounded, and both ends of the cut side is formed in a semicircular shape or the corners of the cut side are rounded through pre-forging.

3. The method of claim 1, wherein rounded portions are formed at short sides and long sides at an inlet of the die and the rounded portion of the short side is larger than the rounded portion of the long side.

4. The method of claim 3, wherein the rounded portion of the short side at the inlet of the die is two to five-time larger than the rounded portion of the long side.

5. The method of claim 1, wherein a land is attached to the punch at the portion facing the die and has long sides higher than short sides.

6. The method of claim 5, wherein the long sides of the land are higher than the short sides only in the range of 50 to 80% of the center.

7. The method of claim 6, wherein the height of the long sides of the land is two to five-time larger than the short sides.

8. The method of claim 1, wherein an assembly ring is wound around the outer side of the die and the inner diameter of the assembly ring is smaller than the outer diameter of the die.

9. The method of claim 1, wherein a larger tolerance is given to the long sides than the short sides of the material and the die.

10. The method of claim 1, wherein a tapered portion is formed from a long side to a short side of the bottom of the die.

11. The method of claim 10, wherein the long side of the die except for the tapered portion has a size for completing the bottom of the complete product, the end is rounded, and the tapered portion is formed at 45% in the range of 1 to 3% of the length of the long side.
